(19) United States
(12) Patent Application Publication
(10) Pub. No.: US 2002/0061045 A1
(43) Pub. Date: May 23, 2002

(54) Portable low-power gas discharge laser

(75) Inventors: Yong F. Zhang, Mill Creek, WA (US); John J. Gearey, Everett, WA (US); Michael R. Adams, Snohomish, WA (US)

Correspondence Address: KOTULA LAW OFFICE, 7727 46TH PLACE WEST, MUKILTEO, WA, 98275, US

(73) Assignee: Access Laser Company

(21) Appl. No.: 09/990,598

(22) Filed: Nov. 20, 2001

Related U.S. Application Data
(60) Provisional application No. 60/252,830, filed on Nov. 21, 2000.

(51) Int. Cl. H01S 3/03

(52) U.S. Cl. 372/61

(57) ABSTRACT

A short cavity gas discharge laser stabilized by use of a highly reflective output coupler adjustably connected to a support isolated from the longitudinal thermal expansion of the laser enclosure. A flexible seal between the output coupler and the laser enclosure accommodates positional adjustment of the output coupler relative to the mirror to optimize performance. In one embodiment, the laser gas is contained by the enclosure and is in contact with the electrodes which divide the interior of the enclosure into two portions that provide gas ballast for the laser. In another embodiment a pair of electrodes are located adjacent to and outside of a discharge tube made of dielectric material. The laser discharge occurs in the discharge tube and the electrodes are not in physical contact with the discharge. Gas ballast is optionally provided through at least one reservoir in fluid communication with the discharge tube.

### CROSS REFERENCE TO RELATED APPLICATIONS

This application claims the benefit, under 35 U.S.C. 119(e), of U.S. provisional application Ser. No. 60/252,830, filed Nov. 21, 2000, pending.

### BACKGROUND OF INVENTION

1. Field of the Invention

The present invention relates, generally, to gas discharge lasers. More particularly, the invention relates to CO and CO₂ lasers. The invention has particular utility in the field of low-power lasers.

2. Background Information

The state of the art includes various techniques and structures for CO₂ lasers. CO₂ lasers have been useful for medical and industrial applications for marking and cutting through various materials. Because they can be fabricated out of aluminum extrusions, they are sufficiently rugged for commercial use. Since the primary use of CO₂ lasers has been to burn materials, the development of CO₂ lasers has been aimed at increasing power and efficiency.

Laser power can be increased by increasing the length of the discharge chamber, but large lasers are not portable and are therefore impractical for many uses. Great efforts have been made to develop high-power compact CO₂ lasers. An early waveguide laser using RF discharge is disclosed in U.S. Pat. No. 4,169,251 to Katherine Laakmann. It uses a discharge region having a rectangular cross-section located between a pair of closely spaced extended electrodes. The length of the laser disclosed is approximately 20 cm, and had an output of approximately 0.2 watts per centimeter. This design became the “conventional” laser design adopted for many uses, but outputs were still generally considered low.

Power levels of up to one kilowatt in a compact unit have been achieved using the “slab” laser design. Here, the width of the electrodes is much greater than the gap between the electrodes. An example of such a laser is seen in U.S. Pat. No. 4,719,639 to Tulip. Lasers typically produce power at 10 percent efficiency, so an output of 100 watts would require one kilowatt of input power. Such high-energy lasers produce a great deal of heat and often have water-cooled electrodes.

There are numerous other patents for CO₂ lasers. U.S. Pat. No. 5,748,663 to Chenausky has a thorough background discussion of the state-of-the-art for CO₂ lasers. Chenausky summarizes the dimensions of the prior art slab lasers has having electrode lengths that range from about 30 to 77 cm. Chenausky's laser is in the range of 30-35 cm as well and produces power of approximately 100 watts per meter.

All of the prior art CO₂ lasers have lengths over 30 cm's and produce at least several watts of output power.

There is a need for a low-power CO₂ laser for scientific use such as spectral analysis, or for industrial applications such as welding plastic on fiber optic cable. Currently the lowest power CO₂ laser still produces several watts of output power. Filters can be used to absorb most of the output power, but that is terribly inefficient. The length of the discharge tube cannot simply be reduced to reduce the power because lasers made according to the techniques disclosed in the prior art, but with shorter discharge lengths, on the order of 10-15 cm, become very unstable.

The present invention provides a compact low-power laser which overcomes the limitations and shortcomings of the prior art.

### SUMMARY OF INVENTION

The present invention provides a short cavity gas laser that is stabilized by use of a highly reflective output coupler adjustably connected to a support isolated from the longitudinal thermal expansion of the laser enclosure. A flexible seal between the output coupler and the laser enclosure accommodates positional adjustment of the output coupler relative to the mirror to optimize performance of the laser.

The enclosure contains laser gas and a pair of elongated electrodes with a discharge area between the electrodes in which laser discharge occurs. The enclosure has a first end with an opening and a second end opposite the first end with an attached mirror. The mirror is located near one end of the discharge area. A support is located outside of the enclosure and is attached to the enclosure near the second end. The support has a flange extending inwardly toward the opening in the first end of the enclosure. A cap is disposed between the flange and the first end of the enclosure. The cap has an aperture covered with an attached output coupler located near another end of the discharge area opposite the mirror. The cap is movable relative to the flange and the first end of the enclosure. There is a flexible seal between the first end of the enclosure and the cap. At least one adjustment device is connected to the flange and contacts the cap to adjustably position the cap so as to align the output coupler with the mirror for optimum performance of the laser. The flexible seal accommodates adjustment of the cap without compromising integrity of the seal.

In one embodiment, the enclosure has an interior divided into two portions by the electrodes mounted opposite each other therein and the electrodes are in contact with the laser gas. The laser gas is contained in the portions of the interior of the enclosure to provide a gas ballast for the laser.

In another embodiment the enclosure contains a discharge tube disposed between the electrodes and made of low loss dielectric material. The laser discharge occurs in the discharge tube. The enclosure can contain a gas reservoir in fluid communication with the discharge tube to provide gas ballast for the laser when necessary. The external electrodes are not in direct contact with the laser gas.

The features, benefits and objects of this invention will become clear to those skilled in the art by reference to the following description, claims and drawings.

### BRIEF DESCRIPTION OF DRAWINGS

FIG. 1 is a plot of the gain curve for a CO₂ laser and longitudinal modes of resonance for a typical high-power CO₂ laser.

FIG. 2 is the plot of FIG. 1 illustrating drift of the longitudinal modes due to thermal expansion of the laser.

FIG. 3 is a plot of the gain curve for a CO₂ laser and longitudinal modes of resonance for a short-cavity laser.

FIG. 4 is the plot of FIG. 3 illustrating drift of the longitudinal modes due to thermal expansion of the laser.

FIG. 5 is a plot of the gain curve for a CO₂ laser and longitudinal modes of resonance for a short-cavity laser of the present invention illustrating a reduced lasing threshold resulting from use of a more reflective output coupler.

FIG. 6 is a cross-sectional view of a portion of a short-cavity laser of the present invention.

FIG. 7 is a cross-sectional view of a portion of the laser of FIG. 6 taken along line 7-7 illustrating one embodiment of a configuration for electrodes and gas reservoirs.

FIG. 8 is the view of FIG. 7 illustrating another embodiment where the enclosure has internal fins.

FIG. 9 is a perspective view of a portion of another embodiment with the end cap exploded away from the enclosure and illustrating a configuration for electrodes and gas reservoirs where the external electrodes are not in contact with the laser gas discharge.

FIG. 10 is an end view from the discharge end of another embodiment of a short cavity laser of the present invention.

FIG. 11 is a cross-sectional view of the laser of FIG. 10 taken a long line 11-11.

FIG. 12 is the view of FIG. 7 illustrating the electrical connections for the structure.

FIG. 13 is an electrical diagram of the equivalent circuit for the structure illustrated in FIG. 12.

FIG. 14 is a perspective view of a portion of a high-power laser of the present invention using the internal structure of FIG. 9, but having electrodes segmented along their length, and illustrating how each segment is separately driven.

FIG. 15 is a perspective view of a portion of another embodiment of a laser of the present invention illustrating the use of gas reservoirs also as electrodes.

FIG. 16 is an illustration of the electrical field between the two electrodes of FIG. 7.

### DETAILED DESCRIPTION

While the present invention is described for a laser in which the working component of the laser gas is CO₂, the invention is also applicable to lasers using CO or another gas as the working component of the laser gas and is not limited to CO₂ lasers.

Problem with Short CO₂ Lasers

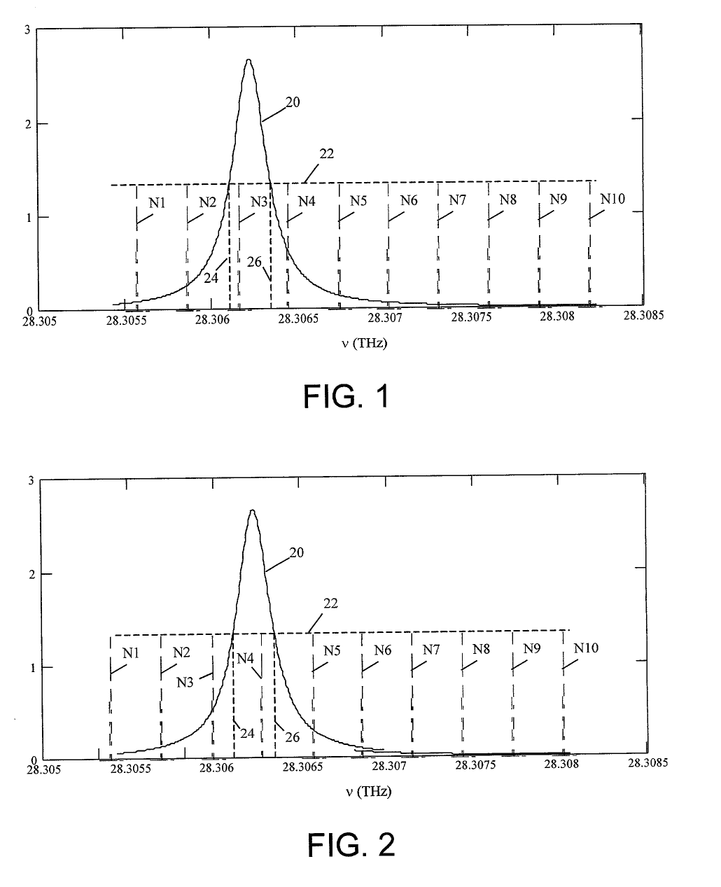

Lasers cavities have tens of thousands longitudinal harmonic modes of oscillation along the frequency spectrum. If one of those modes falls within the gain bandwidth for a particular molecule, that mode can be made to oscillate such that the lasing condition occurs. Referring to FIG. 1, the gain bandwidth curve 20 for a CO₂ laser is illustrated. The lasing threshold 22 is the energy level above which lasing will occur, and is a function of the reflectivity of the optics, as will be discussed later. Thus, for a given lasing threshold, there is an operational bandwidth at which lasing will occur represented by the distance between lines 24 and 26. The vertical lines N1 through N10 represent longitudinal modes of resonance. Their height represents the lasing threshold. If a mode, in this case N3, falls within the operational bandwidth on gain bandwidth curve 20 the laser is capable of oscillating at sufficient energy that lasing occurs.

The free spectral range, represented by the distance between each vertical line N1-N10, for a laser resonator is inversely proportional to the length of the resonator. The length of a laser resonator is the distance between the two optical mirrors. The optical mirrors are typically mounted to the ends of the case, which is typically an aluminum extrusion. The free spectral range illustrated in FIG. 1 is representative of a CO₂ laser of approximately 45 cm. Since molecular lasers have a very narrow gain bandwidth in the spectral range, it takes very little drift of the longitudinal mode for a particular mode to fall out of the operational bandwidth where lasing will occur. Such drift of the longitudinal mode occurs as the length of the resonator changes due to thermal expansion and contraction of the case to which the optical mirrors are mounted. FIG. 2 represents the drift of longitudinal mode when the length of the resonator changes by 5 micrometers, which is caused by a temperature change of approximately 0.5 degree C of a 45 cm long aluminum structure. The longitudinal mode represented by line N3 has moved out of the operational bandwidth area between lines 24 and 26, but another mode represented by line N4 has moved in, and therefore the laser continues to operate. Thus, for long length resonators, drift of the longitudinal mode caused by thermal expansion and contraction of the case is not very detrimental to the operation of the laser.

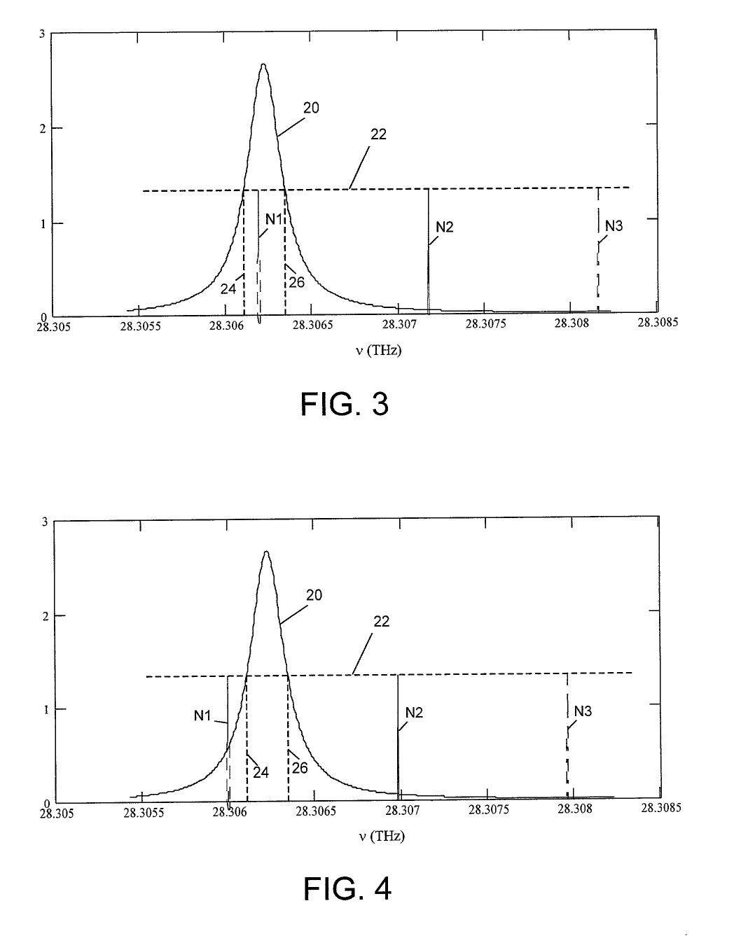

For a laser using a short cavity resonator, however, it is likely that the free spectral range is significantly wider than that of the operational bandwidth. Referring to FIGS. 3 and 4, the free spectral range for a resonator length of 15 cm is illustrated by the distance between each vertical line N1-N3. In FIG. 3, a mode represented by line N1 falls within the operational bandwidth between lines 24 and 26, so the laser operates. But as can be seen in FIG. 4, the same drift of the longitudinal mode due to a 5 micrometer change in resonator length moves the mode represented by line N1 outside of the operational bandwidth, but the next mode represented by line N2 does not moved into it. All the cavity modes are outside of the operational bandwidth of the gain curve, therefore there is no laser operation. This 5 micrometer expansion is caused by an approximately 1.5 degree Celsius increase in temperature for a 15 cm. long, aluminum cavity. Thus, a typical laser that uses a short resonator will exhibit significant output instability due to resonator distance changes caused by thermal expansion and contraction of the case.

For a resonator length of 15 cm, the free spectral range is almost 1 GHz. For a typical C02 laser with a working gas pressure of 50 torr, the full width of the gain curve is only 240 MHz. Therefore, the laser power can fluctuate up to 100% when the longitudinal mode pattern moves in and out of the gain spectrum as a result of the cavity expansion and contraction due to temperature changes.

Solution with Highly Reflective Optics

The present invention overcomes this problem by using an output coupler with very high reflectivity. A laser uses an optical resonator that contains two mirrors at opposite ends of the resonator cavity that reflect the light between them to provide positive feedback required for operation. One of the mirrors is partially transmissive to allow the laser beam to emit, and it is called the output coupler. The amount of energy transmitted through the partially transmissive output coupler is the output of the laser. The goal of most lasers is to have maximum output, and therefore the reflectivity and transmissivity of the output coupler typically is optimized for maximum power. There is a trade-off between the reflectivity and the transmissivity of the output coupler. For transmissivities less than optimum, higher transmissivity (and, thus, lower reflectivity) produces higher output, but requires a higher lasing threshold to maintain the lasing effect since there is less energy reflected between the two mirrors. The higher required lasing threshold narrows the operational bandwidth on the gain curve as discussed above and, therefore, reduces the stability of the laser. Most CO₂ lasers operate with output couplers having a reflectivity of less than 95 percent and that require a relatively high lasing theshold as illustrated FIGS.1-4, which is a good compromise between output and stability of the laser if the cavity is long enough, as discussed above.

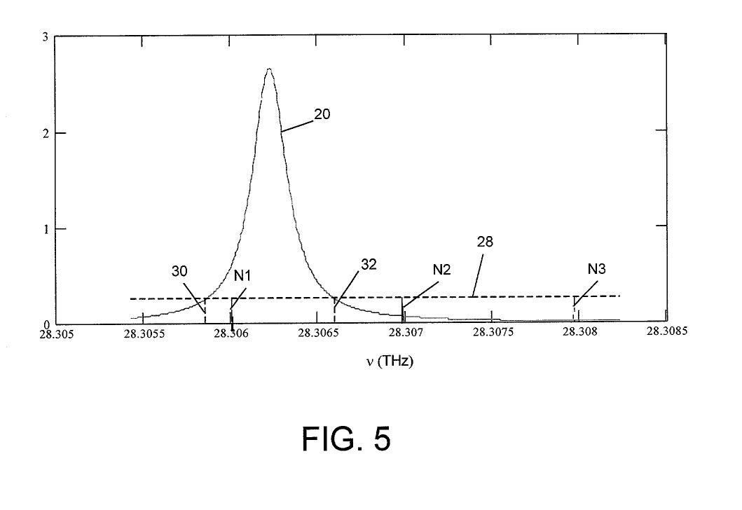

For a low-power laser, output couplers that are more highly reflective, preferably greater than about 97 percent, can be used. The reduced output associated with the more highly reflective output coupler is a desirable feature. Referring to FIG. 5, the higher reflectivity produces a lasing threshold 28 substantially lower on the gain curve 20, which broadens the operational bandwidth represented by the distance between lines 30 and 32. The vertical lines N1-N3 are the same longitudinal modes as in FIG. 4, which represent a drift due to a 5 micrometer cavity expansion. The mode represented by line N1 is now within the operational bandwidth, so the laser operates. The operational bandwidth approaches the free spectral range, which increases the laser stability during thermal expansion and contraction. Therefore, conditions for laser operation during thermal expansion and contraction are strongly enhanced.

Structure to Minimize Thermal Drift

Aluminum alloys have been used in the structure of RF excited lasers because of their superior electrical conductivity, thermal conductivity, and mechanical strength. However, the large thermal expansion coefficient of aluminum compromises the stability of the lasers. This is particularly acute for short cavity lasers, as discussed above. Thermal drift can be minimized if the structure supporting the optics has a minimum coefficient of thermal expansion. For very large lasers, this has been done in the past using a gantry type arrangement were the optics are mounted on the gantry which is separate from the laser cavity structure that is susceptible to great thermal variation.

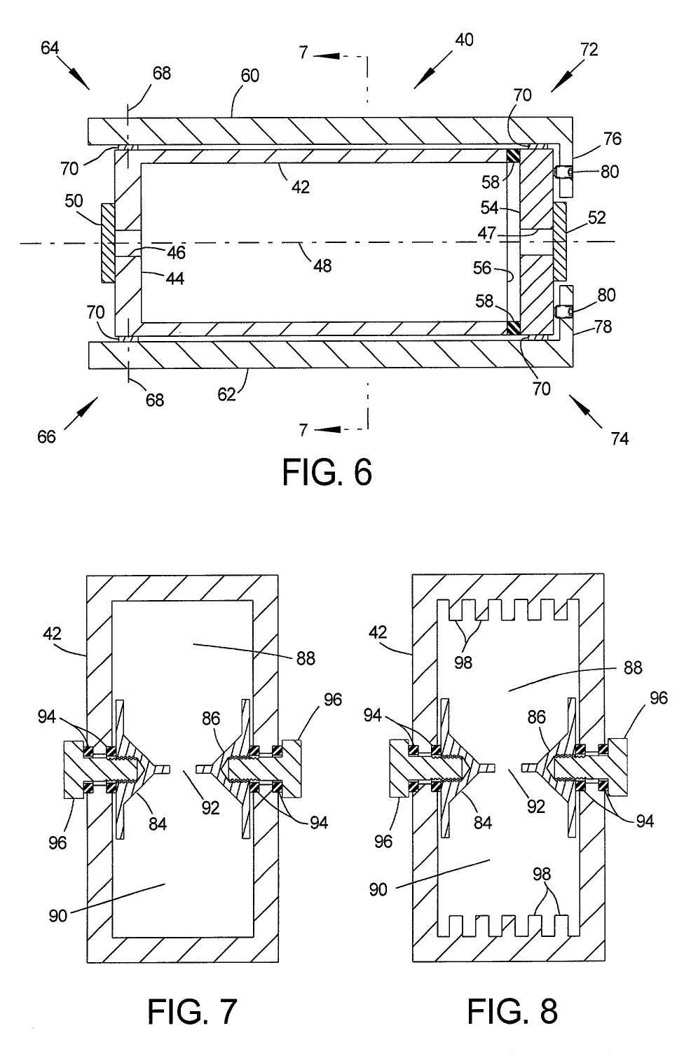

Referring to FIG. 6, a preferred embodiment for the support structure of a short cavity laser 40 of the present invention is illustrated. In this structure the enclosure 42 contains the laser gas, the elongated electrodes, and a discharge area, arrangements for which will be discussed below. The enclosure 42 is preferably made of aluminum and is typical of conventional enclosures for lasers.

The rear wall 44 of enclosure 42 and cap 54 each have a central aperture 46 and 47 respectively which aligns with the laser discharge axis 48. The mirror 50 is fastened to the outside of rear wall 44 over aperture 46, such as by screws, adhesive, or other well-known fastening means. The output coupler 52 is similarly fastened to the outside of cap 54 over aperture 47.

Cap 54 is not rigidly fastened to front end 56 of enclosure 42, which thereby decouples the length of the resonator cavity between mirror 50 and output coupler 52 from the thermal expansion of aluminum enclosure 42.

A flexible seal 58, such as a metal bellows or elastomeric gasket, is disposed between front end 56 of enclosure 42 and cap 54 and provides a gas-tight seal between those components.

A support, such as a pair of rails 60, 62 is disposed outside of enclosure 42 and cap 54. The rear ends 64 and 66 of rails 60 and 62 respectively are preferably fastened to the rear wall 44 of enclosure 42 such as by screws indicated by centerlines 68. Spacers 70 preferably are used to separate rails 60, 62 from enclosure 42, which enhances thermal isolation between the components. The front ends 72 and 74 of rails 60 and 62 respectively have flanges 76 and 78 respectively extending inward from rails 60 and 62 respectively. Flanges 76 and 78 each have preferably three, but at least one set screw 80, threadably engaged with the flanges and extending through the flanges to contact cap 54. Set screws 80 push cap 54 toward front end 56 of enclosure 42 to firmly compress seal 58. Spacers 70 may also be used between the outside of cap 54 and rails 60 and 62.

Rails 60 and 62 are preferably made of material having a very low longitudinal coefficient of thermal expansion. The preferred material is Invar, but other materials such as carbon fiber composites may also be used. The thermal drift associated with the changing length between mirror 50 and output coupler 52 is driven by the thermal expansion of rails 60 and 62 rather than the thermal expansion of enclosure 42. Flexible seal 58 absorbs the difference in thermal expansion between the rails 60, 62 and enclosure 42.

The distance between the mirror and the output coupler for a laser of the present invention is typically less than 30 cm and preferably about 12 to 18 cm, although the techniques described herein can also be applied to longer-cavity lasers. The maintenance of the distance between mirror 50 and output coupler 52 and their relative orientation is very important to the stability of laser output. In the case where the gas discharge chamber is also part of the cavity, the alignment of these components to the chamber is also highly critical. The adjustment of set screws 80 and the flexibility of seal 58 provide the ability to precisely align output coupler 52 with mirror 50 and adjust the distance between them for optimum performance of laser 40. Set screws 80 also compress flexible seal sufficiently to seal enclosure 42. The flexible seal 58 accommodates adjustment of the cap 54 without compromising the integrity of the seal.

Referring to FIG. 7, air inside enclosure 42 is evacuated and replaced with laser gas. Elongated electrodes 84 and 86 are mounted inside of enclosure 42 opposite each other and divide the interior of enclosure 42 into two portions 88 and 90 which contain the laser gas and are in fluid communication with each other across channel 92. The electrodes 84 and 86 are in contact with the laser gas and are insulated from each other and from enclosure 42 by insulators 94, and will establish a discharge inside channel 92. Bolts 96 secure electrodes 84 and 86 to enclosure 42 and also provide electric power feed-through to electrodes 84 and 86.

Portions 88 and 90 form a gas ballast section needed because species of the laser gas will be consumed slowly during the course of laser operation and storage. The gas can be stored in the exact composition of species desired for the laser operation, or different species can be stored separately and allowed to freely exchange with the gas in channel 92 discharge section to maintain a constant gas composition therein. Besides containing the laser gas, enclosure 42 provides a mechanical reference for the electrodes and it dissipates heat to the environment.

Channel 92 forms an elongated gas chamber in the direction of desired laser beam formation. Electrodes 84 and 86 provide electric power to break down the gas in channel 92 to form the laser discharge. Channel 92 forms part of the optical cavity to provide waveguiding or reflection to the laser beam generated within.

Referring also to FIG. 16, the discharge and laser transverse mode is bounded in the vertical dimension by electrodes 84 and 86, but in the horizontal direction there is no solid boundary for the discharge. It is desirable that the discharge have only the fundamental transverse mode. As the shape of the discharge widens, higher order transverse modes are possible. In all prior art technologies, transverse mode control is accomplished either by providing solid boundaries all around the discharge or by using multi-pass resonator cavities. This embodiment, illustrated by FIGS. 6-7, uses a single- pass stable resonator with no solid boundary all around the discharge. For this configuration, the laser discharge can be confined to the fundamental transverse mode by selecting a proper electrode width as a function of inter-electrode gap and RF power. The proper selection of these parameters results in the electric field, as illustrated by field lines 97, having a generally round shape, and therefore the discharge is also in that shape and exhibits only the fundamental transverse mode. For example, for an RF power of less than 10 watts and a inter-electrode gap of 4 mm, an electrode width of 1 mm produces a generally round discharge shape that exhibits only the fundamental transverse mode. When electrode width reaches 3 mm for the same 4 mm gap, the discharge shape is more elliptical and exhibits the second harmonic mode.

Referring to FIG. 8, limited heat dissipation from the gas discharge or gas storage chambers has always been one factor that limited the power level of non-internally-water-cooled lasers. Enclosure 42 has internal fins 98 that greatly increase the total surface area inside enclosure 42. This helps transfer the internal heat into enclosure 42 to achieve better thermal dissipation of the heat generated by laser operation which allows gas discharge lasers to be made more compact. Fins 98 also break down the acoustic Q of the gas discharge and storage chambers, so that the discharge can remain stable under modulation. Alternatively fins 98 can be replaced by hard foam Aluminum that has an even higher surface area to volume ratio.

External Electrode Embodiments

One characteristic of RF discharge is that the electromagnetic field can permeate through dielectric materials. This makes it possible to place the electrode in the atmosphere and strike a discharge in a separate chamber filled with proper laser gas. Such discharge chambers are made of tubes of low loss dielectric material such as Al₂O₃ ceramic or quartz, which are in ample supply. Depending on the diameter of the tube and the length of the cavity, these tubes can provide waveguiding to the laser beam. However, the volume of such a discharge chamber is usually very small. For the laser to have a long life, extra gas ballast is needed.

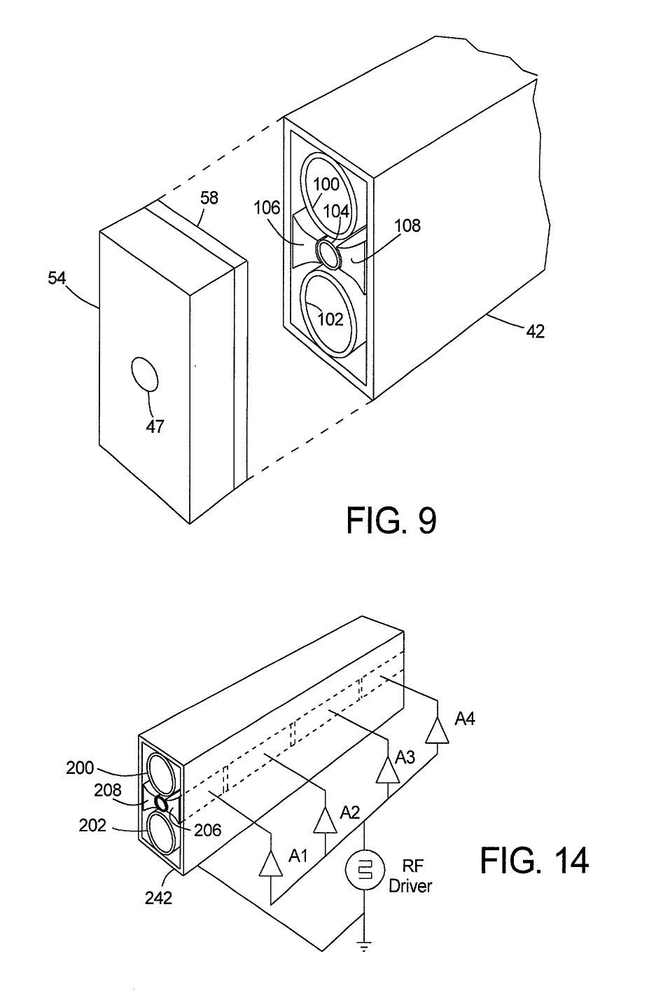

Referring to FIG. 9, another embodiment of a short cavity laser of the present invention uses electrodes external to the discharge chamber. In this embodiment, enclosure 42 does not directly contain the laser gas, and is therefore not evacuated. Rather, a pair of tubes 100, 102 contain the laser gas, and the tubes 100, 102 are contained in enclosure 42. A discharge tube 104 made of low lass dielectric material is located between tubes 100 and 102 and forms the laser discharge chamber. Tubes 100 and 102 form the gas ballast and their interiors are in fluid communication with the interior of discharge tube 104 through permeable seals or directly through passages machined in cap 54. Discharge tube 104 is preferably supported by and seals to aperture 47 in cap 54. Electrodes 106 and 108 are insulated from each other and from enclosure 42. They will establish a discharge inside of discharge tube 104. In this embodiment, enclosure 42 is not evacuated since the laser gas is contained in tubes 100 and 102 and is not in direct contact with the electrodes 106 and 108. Only the tubes 100 and 102 and discharge tube 104 are evacuated and then filled with laser gas.

With the electrodes 106 and 108 outside of discharge tube 104, the electrodes are exposed to ambient conditions rather than an evacuated environment with laser gas at low pressures as they are in prior art lasers. This provides several advantages over prior art lasers. First, because there is no pressure differential across the feed-through for the wires to the electrodes through the enclosure 42, the feed-throughs do not need to have vacuum-tight seals. This greatly simplifies the feed-through and allows a variety of materials to be used. Second, electrodes can be made of materials other than aluminum, which is conventionally used for electrodes. Aluminum is most often used for electrodes because it is resistant to corrosion in the low-pressure laser gas environment. With the electrodes in an ambient environment, they could be made of copper without significant risk of detrimental corrosion. Copper cannot be used in a laser gas environment because it is heavily oxidized in the laser gas discharge and it robs oxygen from the CO₂ in the laser gas. Third, the ambient conditions inside enclosure 42 allow bonding material, such as epoxy or other resins, to be used to assemble components. With prior art lasers where the enclosure is evacuated and filled with laser gas, epoxy cannot be used because of out-gassing which poisons the laser gas, thereby killing the laser.

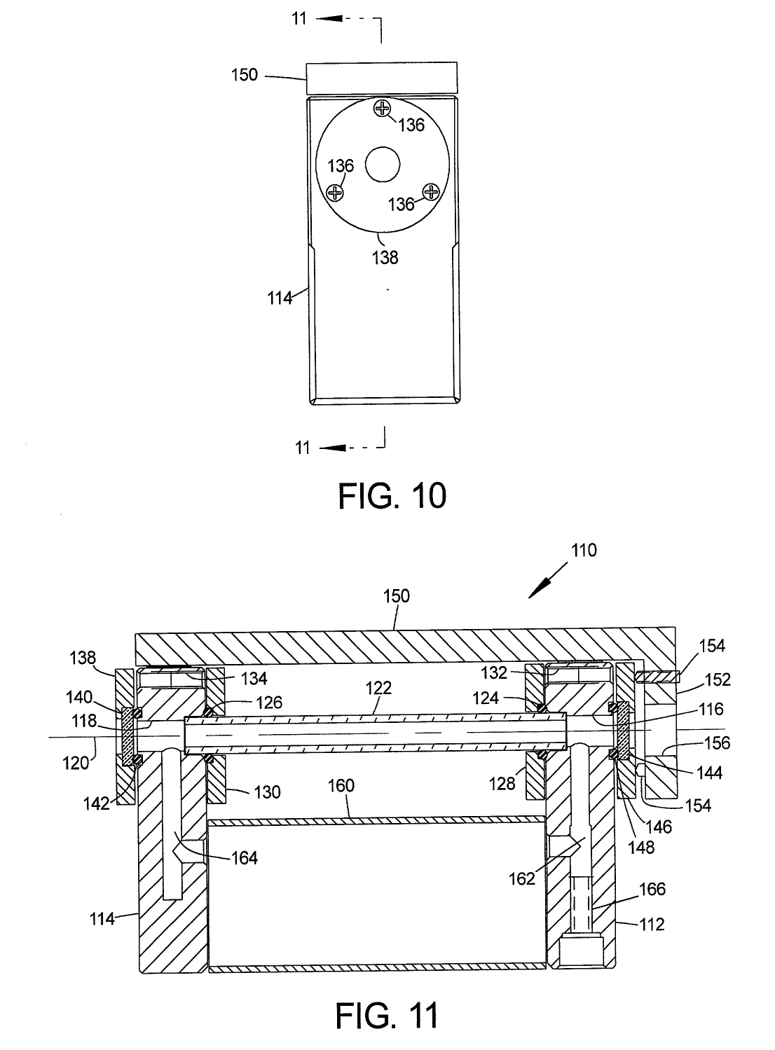

Referring to FIGS. 10 and 11, another embodiment of a short cavity laser of the present invention using external electrodes is illustrated. Laser 110 has a pair of combiner blocks 112, 114 in spaced parallel arrangement at each end. Combiner blocks 112 and 114, preferably made of aluminum, have apertures 116 and 118 respectively which are aligned with discharge axis 120 and which receive and support discharge tube 122 in which the laser discharge occurs. Discharge tube 122, preferably made of low loss dielectric material, such as ceramic, is sealed to the inside of combiner blocks 112 and 114 by flexible seals 124 and 126 respectively, which preferably are elastomeric O-ring seals. Seal caps 128 and 130 are fastened to combiner blocks 112 and 114 respectively, preferably by screws (not shown) threadably engaged with threaded apertures 132 and 134 respectively such that seal caps 128 and 130 compress seals 124 and 126 respectively against combiner blocks 112 and 114 respectively and discharge tube 122 to provide a gas-tight seal between discharge tube 122 and combiner blocks 112 and 114.

Apertures 132 and 134 are a plurality, preferably three, of threaded apertures preferably uniformly spaced about discharge axis 120. In the embodiment shown, apertures 134 receive screws both from the inside to hold seal cap 130 and screws 136 from the outside to hold mirror cap 138 in which mirror 140 is centrally positioned on discharge axis 120. Flexible seal 142, preferably an elastomeric O-ring seal provides a gas-tight seal between mirror 140 and aperture 118. Screws 136 provide compression of flexible seal 142 and allow adjustment of mirror 140 to optimize performance of laser 110. It is desirable that apertures 134 receiving screws 136 on the outside of combiner 114 be positioned near the outside of mirror cap 138 to provide maximum adjustment sensitivity. However, since the internal seal cap 130 need not be adjusted, apertures 134 receiving screws (not shown) from the inside to hold seal cap 130 could be positioned closer to discharge tube 122, thereby reducing the diameter of seal cap 130 and allowing chamber 160 to be positioned closer to discharge tube 122. In that case, apertures 134 would not necessarily be continuous through-holes as shown.

Output coupler 144 is retained by cap 146 and compresses flexible seal 148 against combiner 112 to provide a gas-tight seal between output coupler 144 and aperture 116 in a manner similar to that described for laser 40 in FIG. 6. A rail 150, preferably made of Invar or other suitable material having low longitudinal thermal expansion properties, such a carbon fiber composite, is rigidly fastened to combiner 114 and flexibly fastened to combiner 112. Rail 150 has a flange 152 extending downward in front of combiner 112 and cap 146 and provides for threaded set screws 154 to push against cap 146 to thereby compress flexible seal 148 and allow adjustment of output coupler 144. A laser cavity is formed along the inside of the discharge tube 122 between the mirror 140 and the output coupler 144. The laser beam transmitted through output coupler 144 passes through aperture 156 in flange 152 aligned with discharge axis 120.

Electrodes (not shown) are positioned adjacent to and outside of the discharge tube 122 on opposite sides of the discharge tube 122 in a manner similar to that shown in FIG. 9. The electrodes are in a non-evacuated environment and are not in contact with the laser discharge which occurs in discharge tube 122.

Gas reservoir 160 is disposed between combiners 112 and 114. In the embodiment shown, gas reservoir 160 is a tube sealably welded to both combiners. The interior of gas reservoir 160 is in fluid communication with the interior of discharge tube 122 through passages 162 and 164 in combiner blocks 112 and 114 respectively. Gas reservoir 160 provides the same function as tubes 100 and 102 discussed in FIG. 9. Passage 162 in combiner block 112 has an extension 166 which extends vertically downward and out the bottom of combiner block 112 to make a gas fill port for the laser 110. Extension 166 provides for attachment of a fitting (not shown) to permit gas to be put into gas reservoir 160. In an alternate embodiment, (not shown) gas reservoir 160 is sealably welded only to combiner block 112 and is in fluid communication with discharge tube 122 only through passage 162. Combiner block 114 does not have passage 164.

Gas reservoir 160 my be omitted completely, thus limiting the lifetime of the laser to that produced by the gas contained in discharge tube 122. This lifetime may be sufficient for some applications.

Electrical Tuning

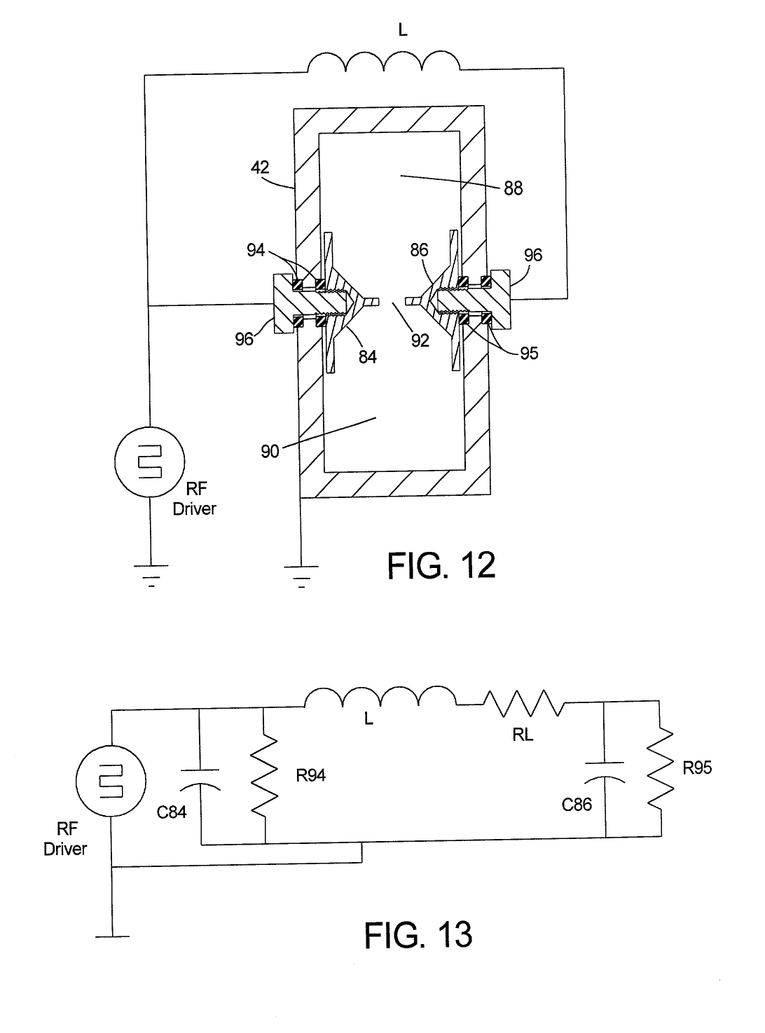

FIGS. 12 and 13 describe the electrical aspects of the laser illustrated in FIGS. 6-7. FIG. 12 illustrates the physical components and their electrical connections, along with an RF driver power supply and matching networks, and a resonant inductor L. FIG. 13 represents the equivalent electrical circuit. C84 is the capacitance between electrode 84 and enclosure 42, C86 is the capacitance between electrode 86 and enclosure 42, R94 represents the loss in the insulating material 94, R95 represents the loss in insulating material 95, RF Driver represents the source and matching network, L is the inductance of inductor L, and RL represent the loss in the inductor L.

Electrically, the laser structure is a high quality (Q), circuit tuned to precisely resonate with the RF driver frequency. Because the low-power laser relies on RF drivers with output power as low as a few watts, it is critical for the laser structure to electrically possess a very high Q to achieve the high voltage required for gas breakdown across the electrodes. All material used in this structure, conductors and insulators, needs to have very low loss at the RF driver frequency. This means that R94, and R95 need to be maximized and RL minimized. The structure then needs to be fine-tuned to electrically resonate within 0.5 MHz of the RF driver frequency.

Using the Structure of the Present Invention for High-power Lasers

In conventional high-power gas discharge lasers, the electrodes are entirely within an evacuated chamber. For a 500 watt CO₂ laser requiring about 5 kw of RF power, the total power is fed to the electrodes through a single vacuum feed-through to minimize the number of openings in the evacuated chamber. The requirements of low RF loss, vacuum-tight, low outgassing rate, and thermal-mechanical compatibility between mating materials make these RF feed-throughs very expensive.

Referring to FIG. 14, the structural configuration for a low-power laser illustrated in FIG. 9 can also be applied to high-power lasers. By containing the laser gas in tubes 200 and 202, container 242 is not evacuated, thereby simplifying electrical feed-through to the external electrodes 206, 208 which allows the laser designer to choose from a much larger pool of materials for the feed-throughs.

Additionally, a state-of-the-art MOSFET transistor operating in the RF frequency range is capable of delivering about 200 watts of power. The standard technique in making RF drivers for high power lasers is to use power combiners after the final amplifier stage. These power combiners are cumbersome and consume power themselves. That technique is used due to the desire to minimize the number of vacuum RF feed-throughs. By eliminating the expensive vacuum-tight RF feed-throughs with the external electrodes, the design illustrated in FIG. 14 allows the RF power to be fed from separate amplifier modules A1-A4 into separate pairs of electrodes withot using power combiners. These amplifier modules A1-A4 can all be driven form a single RF driver source, as illustrated, or they may be driven separately.

Another difficulty with high power RF excited discharge lasers is that as the electrodes become wider and longer, they approach the wavelength of the excitation source and the distribution of the voltage across the electrode becomes none-uniform. This problem is alleviated by dividing the electrodes 206, 208 into segments, each of which is much shorter than the RF wavelength. Each segment is driven by a separate RF amplifier module A1-A4.

Another difficulty with high power discharge lasers is cooling of the electrodes inside the evacuated enclosure. Coolants such as water must be tightly sealed to vacuum requirements so that no water leaks into the laser gas. Any slight leakage results in immediate failure of the laser. With an external electrode arrangement of the present invention, the electrodes are at ambient condition and cooling water need only be sealed as well as conventional plumbing is sealed.

Alternative Gas Reservoirs

Gas deterioration usually results from the change in the ratio among gas species. Different gas species permeate at different rates through vacuum seals and are consumed differently internally during laser operation. The present invention illustrates how a plurality of chambers can be used for gas ballast. Alternatively, rather than filling the chambers with mixed laser gas, each species of the laser gas could be stored in a separate chamber that can provide it at the appropriate proportion to the discharge chamber.

The main gas components of CO₂ lasers are N2, CO₂, He, and Xe. During laser operation CO₂ molecules disassociate to form CO and a variety of Oxygen species. The latter will in turn form oxide with the metal surfaces and other gas species. As a result CO₂ molecules are consumed gradually and laser power will drop. A single gas ballast chamber can be filled with all the components of the working laser gas at the same partial pressures as in the working discharge chamber, with the exception of a higher pressure for O₂. Such a chamber is called a “positive Oxygen chamber”. The discharge chamber can be connected to the positive oxygen chamber through a permeable seal with a known permeation rate that will compensate for the oxygen loss inside the discharge chamber. Thus the loss of CO₂ in the discharge chamber will be diminished and the laser lifetime improved significantly. The O₂ pressure in the positive Oxygen chamber can be very high so the laser lifetime is extended for a very long period of time with a small volume.

Molecular sieves have long been used in molecular separation processes because of their strong adsorption of polar molecules, such as CO₂. Among the gas components in the CO₂ laser mixture, the CO₂ molecule is the most polar, and therefore will be most strongly adsorbed in the presence of proper molecular sieves. Molecular sieves can adsorb up to 10% of their own weight in CO₂ molecules. Such a product is molecular sieve No. 4 A. or No. 13 X manufactured by UOP, 25 East Algonquin Road, Des Plaines, Ill., 60017. The molecular sieves are manufactured as pellets, which can then be packed into a container, such as tubes 100 and 102 of FIG. 9. According to the information supplied by UOP, a pack of 2 grams (less than a hand-full) of type 4A molecular sieve with a saturated partial pressure at 4 torr will hold 0.16 gram of CO₂ molecules. This is equivalent to about 20 liters of laser gas. Thus, using a molecular sieve as a gas reservoir provides very large equivalent gas ballast with a fraction of physical volume, and extends the lifetime of CO₂ lasers. This solid phase gas reservoir can be used for CO₂ lasers at all power levels significantly reducing their size and weight.

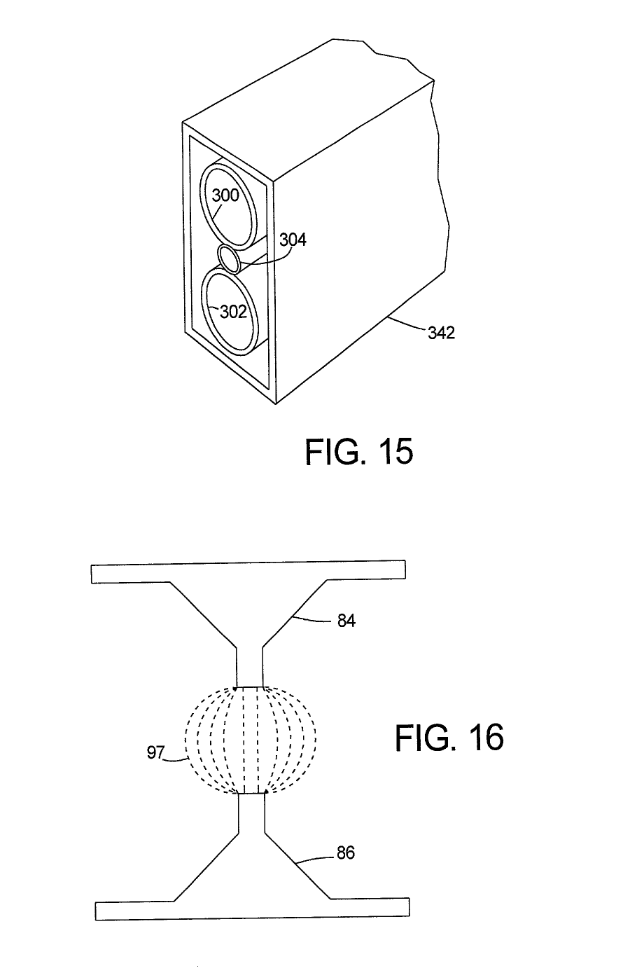

Referring to FIG. 15, gas reservoirs 300 and 302 can be electrically isolated from enclosure 342 and themselves function as the electrodes to produce the discharge in discharge tube 304. In this embodiment, the outer surface of gas reservoirs 300 and 302 adjacent discharge tube 304 is contoured to receive the outer surface of discharge tube 304. This use of the same structure as the electrode and as a gas reservoir greatly simplifies the construction of the laser.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. The invention described is not limited to low-power lasers. The invention can be used in lasers at all power levels to reduce the physical size, enhance the reliability, extend the useful life, and to increase the operating stability.

1. A gas discharge laser, comprising:
an enclosure in which laser gas is contained and in which a pair of elongated electrodes are mounted with a discharge area between the electrodes in which laser discharge occurs, the enclosure having a first end with an opening and a second end opposite the first end with an attached mirror, the mirror being located near one end of the discharge area;
a support located outside of the enclosure and attached to the enclosure near the second end, the support having a flange proximate the first end of the enclosure extending inwardly toward the opening in the first end of the enclosure;
a cap disposed between the flange and the first end of the enclosure, the cap having an aperture covered with an attached output coupler located near another end of the discharge area opposite the mirror, the cap being movable relative to the flange and the first end of the enclosure;
a flexible seal between the first end of the enclosure and the cap; and
at least one adjustment device connected to the flange and contacting the cap to adjustably position the cap so as to align the output coupler with the mirror for optimum performance of the laser, the flexible seal accommodating adjustment of the cap without compromising integrity of the seal.

2. The laser of claim 1, wherein the support is spaced from the enclosure to enhance thermal isolation between the support and the enclosure.

3. The laser of claim 1, wherein the support is a pair of rails disposed on opposite sides of the enclosure.

4. The laser of claim 1, wherein the support has a low coefficient of thermal expansion longitudinally.

5. The laser of claim 4, wherein the support is made of Invar.

6. The laser of claim 4, wherein the support is made of carbon fiber composite.

7. The laser of claim 1, wherein the at least one adjustment device comprises at least one screw threadably engaged with the flange.

8. The laser of claim 1, wherein the flexible seal is a metal bellows.

9. The laser of claim 1, wherein the flexible seal is an elastomeric gasket and the at least one adjustment device pushes the cap toward the first end of the enclosure to sufficiently compress the flexible seal to prevent the gas contained in the enclosure from leaking past the seal.

10. The laser of claim 1, wherein distance between the mirror and the output coupler is less than 30 cm.

11. The laser of claim 1, wherein the output coupler has a reflectivity greater than about 97 percent.

12. The laser of claim 1, wherein the output coupler has a reflectivity such that a leasing threshold produced on a gain curve is sufficiently low on the gain curve so that operational bandwidth of the laser approaches its free spectral range, thereby increasing stability of the laser.

13. The laser of claim 1, wherein the enclosure has an interior divided into two portions by the electrodes mounted opposite each other therein, the electrodes being in contact with the laser gas, the laser gas being contained in the portions of the interior of the enclosure to provide a gas ballast for the laser.

14. The laser of claim 13, wherein the electrodes have a width and a gap distance between them, the electrode width being sufficiently less than the gap distance so that the laser discharge supports only a fundamental transverse mode in a stable resonator.

15. The laser of claim 13, wherein the enclosure has an internal structure with increased surface area to enhance heat transfer from the laser gas into the enclosure.

16. The laser of claim 15, wherein the internal structure is a plurality of fins.

17. The laser of claim 15, wherein the internal structure is foam aluminum.

18. The laser of claim 1, wherein the enclosure contains a discharge tube disposed between the electrodes and made of low loss dielectric material, the laser discharge occurring in the discharge tube, the electrodes bring external to the discharge tube and not in physical contact with the laser discharge they generate.

19. The laser of claim 18, wherein the enclosure contains at least one gas reservoir in fluid communication with the discharge tube to provide gas ballast for the laser.

20. The laser of claim 19, wherein the gas reservoir comprises two tubes disposed on opposite sides of the discharge tube.

21. The laser of claim 20, wherein the electrodes are the two tubes.

22. The laser of claim 19, wherein the gas reservoir contains molecular sieves holding a high concentration of CO₂ for the gas ballast.

23. The laser of claim 19, wherein the first end of the enclosure comprises a first combiner block to which the gas reservoir and discharge tube are sealably attached and which provides the fluid communication between the gas reservoir and the discharge tube.

24. The laser of claim 23, wherein the second end of the enclosure comprises a second combiner block to which the discharge tube is sealably attached.

25. The laser of claim 24, wherein the second combiner block is sealably attached to the gas reservoir and provides fluid communication between the gas reservoir and the discharge tube.

26. The laser of claim 23, wherein the discharge tube is sealed to the combiner block with a flexible seal.

27. The laser of claim 23, wherein the combiner block has a gas fill port in fluid communication with the gas reservoir which provides for laser gas to be put into the gas reservoir.

28. The laser of claim 18, wherein both elongated electrodes are divided into portions along their length, each portion being driven by a separate amplifier module.

29. The laser of claim 1, further comprising an inductor connected between the electrodes and a RF driver connected directly to one of the electrodes and to the other electrode through the inductor, wherein the circuit electrically resonates within 0.5 MHz of the RF driver frequency.

30. The laser of claim 1, wherein the laser gas has a working component that is CO₂.

31. The laser of claim 1, wherein the laser gas has a working component that is CO.

32. A gas discharge laser, comprising:
a discharge tube made of low loss dielectric material and containing laser gas, the discharge tube having a first end and a second end;
a pair of electrodes located adjacent to and outside of the discharge tube and disposed on opposite sides of it, the electrodes causing a laser discharge to occur in the tube, the electrodes not in physical contact with the laser discharge;
an output coupler located near the first end of the discharge tube; and a mirror located near the second end of the discharge tube, to form a laser cavity along the inside of the discharge tube between the mirror and the output coupler.

33. The laser of claim 32, wherein the output coupler is positionally adjustable relative to the mirror to optimize the laser performance.

34. The laser of claim 32, wherein the electrodes are in a non-evacuated environment.

35. The laser of claim 32, wherein the electrodes are made of copper.

36. A gas discharge laser, comprising:
an enclosure containing;
a) a discharge tube made of low loss dielectric material and containing laser gas, the discharge tube having a first end and a second end;
b) a pair of electrodes located adjacent to and outside of the discharge tube and disposed on opposite sides of it, the electrodes causing a laser discharge to occur in the tube, the electrodes not in physical contact with the laser discharge;
c) at least one gas reservoir in fluid communication with the discharge tube, the gas reservoir containing laser gas to provide gas ballast for the laser;
d) the enclosure having a first end with an opening and a second end opposite the first end with an attached mirror, the mirror being located near one end of the discharge area;
a support located outside of the enclosure and attached to the enclosure near the second end, the support having a flange proximate the first end of the enclosure extending inwardly toward the opening in the first end of the enclosure;
a cap disposed between the flange and the first end of the enclosure, the cap having an aperture covered with an attached output coupler located near another end of the discharge area opposite the mirror, the cap being movable relative to the flange and the first end of the enclosure;
a flexible seal between the first end of the enclosure and the cap; and
at least one adjustment device connected to the flange and contacting the cap to adjustably position the cap so as to align the output coupler with the mirror for optimum performance of the laser, the flexible seal accommodating adjustment of the cap without compromising integrity of the seal.

37. A gas discharge laser, comprising:
an enclosure in which laser gas is contained and in which a pair of elongated electrodes are mounted with a discharge area between the electrodes in which laser discharge occurs, the enclosure having a first end with an opening and a second end opposite the first end with an attached mirror, the mirror being located near one end of the discharge area, the enclosure having an interior divided into two portions by the electrodes mounted opposite each other therein, the electrodes being in fluid communication with each other across the discharge area, the laser gas being contained in the portions of the interior of the enclosure to provide a gas ballast for the laser;
a support located outside of the enclosure and attached to the enclosure near the second end, the support having a flange proximate the first end of the enclosure extending inwardly toward the opening in the first end of the enclosure;
a cap disposed between the flange and the first end of the enclosure, the cap having an aperture covered with an attached output coupler located near another end of the discharge area opposite the mirror, the cap being movable relative to the flange and the first end of the enclosure;
a flexible seal between the first end of the enclosure and the cap; and
at least one adjustment device connected to the flange and contacting the cap to adjustably position the cap so as to align the output coupler with the mirror for optimum performance of the laser, the flexible seal accommodating adjustment of the cap without compromising integrity of the seal.

38. A method of constructing a gas discharge laser, comprising the steps of:
sealably axially supporting a discharge tube made of dielectric material between a mirror and an output coupler so as to form a sealed laser cavity between the mirror and the output coupler along the inside of the discharge tube;
mounting a pair of electrodes adjacent to and outside of the discharge tube and disposed on opposite sides of it so that the a laser discharge occurs in the tube, the electrodes being not in physical contact with the laser discharge; and
evacuating the laser cavity and then installing laser gas into it.

39. The method of claim 38, wherein the mirror and the output coupler are spaced less than 30 cm apart, and wherein the output coupler has a reflectivity of greater than about 97 percent.

40. The method of claim 38, further comprising the steps of:
positionally adjusting the output coupler relative to the mirror to optimize the laser performance.

41. The method of claim 38, further comprising the step of connecting a gas ballast with the discharge tube so that the gas ballast communicates with the discharge tube.

42. In a gas discharge laser having a pair of elongated electrodes with a discharge area between the electrodes, a mirror located near one end of the discharge area and an output coupler located near another end of the discharge area at a distance less than 30 cm from the mirror, a method of stabilizing the laser comprising the steps of:
using an output coupler having a reflectivity greater than about 97 percent;
mounting the output coupler so that it can move relative to the mirror; and
adjusting the distance between the mirror and the output coupler to optimize performance of the laser.

43. A method of stabilizing a short cavity gas discharge laser comprising the steps of:
adjustably connecting a highly reflective output coupler to a support structure isolated from longitudinal thermal expansion of an enclosure for the laser;
positioning the output coupler opposite a mirror attached to the enclosure; flexibly sealing the output coupler to the enclosure; and
positionally adjusting the output coupler relative to the mirror to optimize performance of the laser.
